(19) United States
(12) Patent Application Publication
(10) Pub. No.: US 2019/0371066 A1
(43) Pub. Date: Dec. 5, 2019

(54) Systems and Methods for Providing Virtual Reality Musical Experiences

(71) Applicant: IMEX Media, Inc., Tiburon, CA (US)

(72) Inventor: Anthony N. Shiff, Waterloo (CA)

(21) Appl. No.: 16/000,693

(22) Filed: Jun. 5, 2018

(51) Int. Cl. G06T 19/00; A63F 13/00; G06F 3/01; G10H 1/34

(52) U.S. Cl. CPC G06T 19/006; G10H 1/342; G06F 3/011; A63F 13/00

(57) ABSTRACT

Systems and methods for virtual reality musical experiences are disclosed herein. An example method includes generating a virtual reality avatar of a musician and a virtual reality guitar, receiving input from a first controller that is indicative of a neck hand position of the first controller relative to a virtual neck of the virtual reality guitar, as well as input from a second controller that is indicative of a strumming hand movement performed using the second controller, adjusting a neck hand position of the virtual reality avatar, within a virtual reality display, in response to the neck hand position of the first controller in real-time and a strumming hand action of the virtual reality avatar, within the virtual reality display, in response to the strumming hand action of the second controller in real-time.

### CROSS-REFERENCE TO RELATED APPLICATION(S)

N/A

### FIELD

The present disclosure is directed to virtual reality experiences and more specifically, but not by limitation, to systems and methods that provide a virtual reality musical experience where virtual reality system controller movements are replicated in with a virtual reality avatar and virtual reality musical instrument in real-time. Users are scored for accuracy in their playing in some instances.

### SUMMARY

According to various embodiments, the present technology is directed to a method comprising: generating a virtual reality avatar of a musician and a virtual reality guitar; receiving input from a first controller that is indicative of a neck hand position of the first controller relative to a virtual neck of the virtual reality guitar, as well as input from a second controller that is indicative of a strumming hand movement performed using the second controller; adjusting: a neck hand position of the virtual reality avatar, within a virtual reality display, in response to the neck hand position of the first controller in real-time; and a strumming hand action of the virtual reality avatar, within the virtual reality display, in response to the strumming hand action of the second controller in real-time; and scoring the neck hand position and the strumming hand action in real-time.

According to various embodiments, the present technology is directed to a method comprising: a processor; and a memory for storing executable instructions, the processor executing the instructions to: generate a virtual reality avatar of a musician and a virtual reality guitar within a virtual reality headset; receive input from a first controller that is indicative of a neck hand position of the first controller relative to a virtual neck of the virtual reality guitar, as well as input from a second controller that is indicative of a strumming hand movement performed using the second controller; and adjust: a neck hand position of the virtual reality avatar in response to the neck hand position of the user in real-time as determined from a position of the first controller; and a strumming hand action of the virtual reality avatar in response to the strumming hand action of the user in real-time as determined from a position of the second controller.

According to various embodiments, the present technology is directed to a method comprising: receiving input from each of two controllers comprising a neck hand position controller and a strumming hand controller; controlling display of hands of a virtual reality avatar relative to a virtual reality guitar, within a virtual reality headset based on input from the two controllers; and scoring the input of the two controllers relative to a performance track.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of an example human user and a virtual reality system that are used to practice aspects of the present disclosure.

FIG. 2 is a screenshot of an example virtual reality display provided with a virtual reality display of the virtual reality system of FIG. 1.

FIG. 3 is a screenshot of another example virtual reality display.

FIG. 4 is a flowchart of an example method of the present disclosure.

FIG. 5 is a flowchart of another example method of the present disclosure.

FIG. 6 is a screenshot that illustrates another example virtual reality guitar with a virtual reality guitar strap lock button.

FIG. 7 is a screenshot that illustrates a mixer interface for use in controlling volume levels and deactivation of a virtual reality guitar strap.

FIG. 8 is a schematic diagram of an example computer device that can be utilized to implement aspects of the present technology.

### DETAILED DESCRIPTION

The present disclosure relates generally to systems and methods that provide a virtual reality musical experience. In one embodiment, the present disclosure provides for a virtual reality guitar playing experience where virtual reality controllers are utilized by a user to control a virtual reality avatar in order to play a virtual reality instrument. The relative movements of the virtual reality controllers by a user's hands are translated into movements of a virtual reality guitar player, for example. A strumming hand action is provided using one controller by a first hand of the user and a neck hand position is established using the other controller by an opposing/second hand of the user. In some instances, the user can play along with a performance track. In various embodiments, the user is scored according to an accuracy of their playing relative to the performance track.

In one or more embodiments, the performance track is subdivided into sequences and each of the sequences has a specific duration of time and corresponding hand positions and/or movements. Each of the sequences can be configured with a unique permutation of parameters such as duration of time, required strumming hand action, and required neck hand position. For example, a sequence has a duration of three seconds, a required strumming hand action of three strums during the duration, and a neck hand position that corresponds to a required neck hand position. The user's accuracy relative to these parameters is used to score the user's virtual guitar playing abilities. Various illustrated guides are provided to indicate how the user should move the controllers for each sequence. These and other advantages of the present disclosure are provided in greater detail herein with reference to the collective drawings.

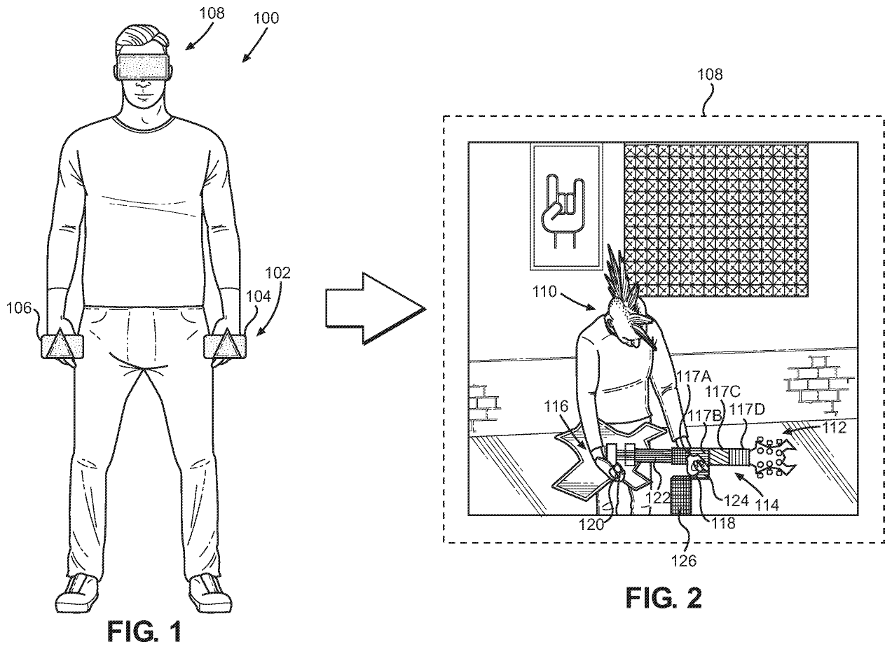

FIGS. 1 and 2 collectively illustrate a user and an avatar in accordance with embodiments of the present disclosure. The user 100 can utilize a virtual reality system 102 which comprises a first controller 104, a second controller 106, and a virtual reality display 108 (such as a headset). As illustrated in FIG. 2, the virtual reality avatar 110 is displayed within the virtual reality display 108 along with a virtual reality guitar 112. The virtual reality guitar 112 comprises a neck 114 and a strumming area 116.

In some embodiments, the neck 114 of the virtual reality guitar 112 is subdivided into a plurality of sections 117A-D. In one or more embodiments, each of the plurality of sections 117A-D is color coded such that section 117A has a first color, section 116B has a second color, section 116C has a third color, and section 116D has a fourth color, with each of the colors being distinct from one another. Each of the plurality of sections 117A-D spans or includes a discrete portion of the neck 114. It will be understood that the colors disclosed above are represented with patterns rather than color, but each unique pattern corresponds to a unique color.

The virtual reality avatar 110 comprises a neck hand 118 and a strumming hand 120. The movements of the neck hand 118 and the strumming hand 120 are selectively adjusted in real-time based on corresponding movements of the first controller 104 and the second controller 106 by the user 100. In some instances, the first controller 104 is associated with the neck hand 118 of the virtual reality avatar 110 and the second controller 106 is associated with the strumming hand 120 of the virtual reality avatar 110.

In some embodiments, the user moves the respective first and second controllers 104, 106 to align with the respective parts of the virtual reality guitar 112. For example, the first controller 104 is moved by the user until the neck hand 118 of the virtual reality avatar 110 aligns with a desired section of the plurality of sections 117A-D of the neck 114 of the virtual reality guitar 112. The second controller 106 is moved by the user until it aligns with the strumming area 116 of the neck 114 of the virtual reality guitar 112. Different sounds are produced and output as the user moves the first controller 104 within the plurality of sections 117A-D and actively strums a set of strings 122 of the virtual reality guitar 112. This movement generates strumming movements using the second controller 106 while the second controller 106 is within the strumming area 116 of the virtual reality guitar 112.

In some embodiments, the user's hand movements are guided using a performance track that is played by the virtual reality system 102. In general, a performance track as disclosed herein comprises a series of sequences that comprise parameters for playing along with music associated with the performance track. In one embodiment, each sequence of the performance track comprises a duration of time along with a required neck hand position(s) and a required strumming action(s).

Using the example above, a sequence has a duration of three seconds, a required strumming hand action of three strums, and a neck hand position that corresponds to a required neck hand position. In use, the user will position the first controller 104 in a required section such as section 117B and operate the second controller 106 to strum the strings 122 of the virtual reality guitar 112 three times during the duration of time of the sequence. When the user's hand positions and strumming patterns correspond to what is required for the sequence, a score of the user is increased, and is correspondingly decreased when the user's hand position and/or strumming patterns are incorrect for the sequence. Also, when the user's hand position and/or strumming patterns are incorrect for the sequence the virtual reality system will output a sound that mimics the error. For example, if a strum action is off time a missed strum sound is played. If the user's neck hand position is errant a dissonant sound is played relative to a backing track (e.g., music).

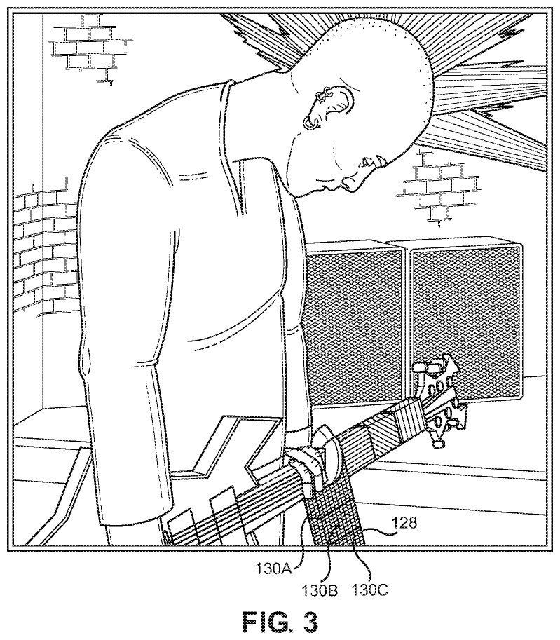

In some embodiments, the strumming patterns can be further defined by a required timing sequence. For example, if the strumming pattern requires three strums during the duration of time of the sequence, the strumming patterns can be further defined by requiring the strumming movements to occur in beat with the background music. In other instances, the timing of the strumming movements can include any number and duration of strums desired. This functionality increases the complexity of the virtual reality music experience for the user and can be used as an additional scoring component. In some embodiments, strum timing/patterning is not required. According to some embodiments, a strum pattern can be indicated with a visual cue, as illustrated and described with respect to FIG. 3 disclosed infra.

The performance track also defines the parameters of visualizations (visual cues) provided during operation as illustrated collectively in FIGS. 1 and 2. For example, when the performance track is executed and the user is playing the virtual reality guitar 112, a time bar 124 is presented in the display that indicates which section of the neck 114 of the virtual reality guitar 112 should be played. The time bar 124 is a solid rectangular object that is colored to correspond to the particular section of the neck 114 of the virtual reality guitar 112 that should be played. It will be understood that the time bar 124 can be represented using any desired geometrical shape and/or size. In some embodiments, a time bar is not required, but the desired neck hand position could be indicated by highlighting or causing a desired section of the guitar neck to flash or illuminate.

A length of the time bar 124 corresponds to the duration of the section (as disclosed above). In some embodiments, the length of the time bar 124 indicates how long the notes or chord being played should be held by the user. In another embodiment, the beginning of a time bar 124 indicates to the user that a strum action should be performed. The next strum action will occur when a subsequent time bar is presented.

In some embodiments, the time bar 124 is displayed underneath a section of the neck 114 of the virtual reality guitar 112. The time bar 124 is also color coded according to the section to which it belongs. The time bar 124 is displayed immediately prior to the duration of time so as to guide a user in positioning the first controller 104 to ensure that the neck hand 118 of the virtual reality avatar 110 is in the required neck hand position required by the time bar (e.g., defined by the particular sequence being played). Thus, each of the sequences of a performance track can be associated with a time bar that is displayed within the virtual reality display, providing guidance to the user as to what section of the neck 114 is being played along with the strumming of the strings of the virtual reality guitar 112.

As noted above, a second time bar 126 is displayed prior to the user having to move the first controller 104 into the first section 117A associated with an upcoming sequence. That is, the sequence the user is currently playing on the virtual guitar is associated with time bar 124 and section 117B of the virtual reality guitar 112. The time bar 124 is shown as moving upwardly. In order for the user to play the sequence associated with the second time bar 126, the user will move the first controller 104 up the neck 114 of the virtual reality guitar 112 and the neck hand 118 of the virtual reality avatar 110 will move correspondingly. In some instances, the neck hand 118 of the virtual reality avatar 110 will be in position in the first section 117A by the time the second time bar 126 contacts the neck 114 of the virtual reality guitar 112 in order for the sequence to be positively scored (also assuming the second controller 106 has been properly used to strum as well).

As illustrated in FIG. 3, in some embodiments, another example time bar 128 is subdivided into a plurality of segments, such as segments 130A-C. Each of the segments 130A-C is indicative of the user strumming and holding a neck hand position. Thus, the segments 130A-C would indicate three strum actions are required for that particular time bar 128.

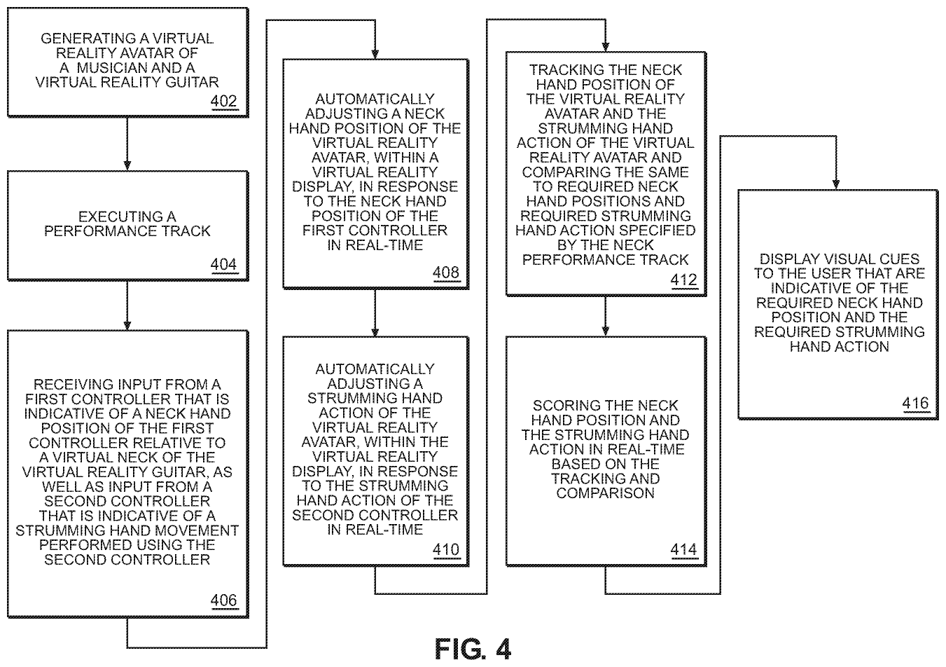

FIG. 4 is a flowchart of an example method of the present disclosure. The method generally includes a step 402 of generating a virtual reality avatar of a musician and a virtual reality guitar. The avatar and guitar are displayed within a virtual reality display, such as a headset, but can also be displayed on any suitable non-virtual reality display in some instances.

In various embodiments, the method includes a step 404 of executing a performance track. In some embodiments, the performance track comprises a set of executable instructions that controls display of visual cues and allows for scoring of user actions relative to the sequences in the performance track. The performance track also comprises music (e.g., backing track) that are unique for each song to be played. Thus, each song played by the user will have a unique performance track associated therewith. The sequences of the performance track are based on the attributes of the song played such as time signatures, bars, movements, and so forth.

As noted above, the performance track comprises a series of sequences that indicate how the user should utilize controllers of a virtual reality system in order to play along with the performance track. Each sequence is comprised of a duration of time for both a required neck hand position and a required strumming hand movement.

Thus, during execution of the performance track, the method further comprises a step 406 of receiving input from a first controller that is indicative of a neck hand position of the first controller relative to a virtual neck of the virtual reality guitar, as well as input from a second controller that is indicative of a strumming hand movement performed using the second controller.

In real-time as the input is received from both the first and second controllers, the method includes a step 408 of automatically adjusting a neck hand position of the virtual reality avatar, within a virtual reality display, in response to the neck hand position of the first controller in real-time. Specifically, this operation positions the neck hand of the virtual reality avatar along neck of the virtual reality guitar.

The method also includes a step 410 of automatically adjusting a strumming hand action of the virtual reality avatar, within the virtual reality display, in response to the strumming hand action of the second controller in real-time. In detail, this operation positions and moves the strumming hand of the virtual reality avatar in accordance with the user's operation of the second controller. That is, as the user creates a strumming motion with the second controller, the corresponding strumming motion is replicated by the strumming hand of the virtual reality avatar.

As the user plays along with the performance track, the method includes a step 412 of tracking the neck hand position of the virtual reality avatar and the strumming hand action of the virtual reality avatar and comparing the same to required neck hand position(s) and required strumming hand action(s) specified by the performance track. This can occur on a sequence-by-sequence basis so that performance/accuracy for each sequence is determined.

Next, the method includes a step 414 of scoring the neck hand position and the strumming hand action in real-time based on the tracking and comparison. For each sequence, when the neck hand position of the virtual reality avatar matches the required neck hand position defined in the performance track and the strumming hand action of the virtual reality avatar matches the required strumming hand action defined in the performance track, the user's movements are positively scored. If either the neck hand position or the strumming hand action do not match what is defined in the performance track the user is scored negatively.

As noted above, the method can also include an optional step 416 of displaying visual cues to the user that are indicative of the required neck hand position and the required strumming hand action. This step 416 can occur contemporaneously with steps 404-414.

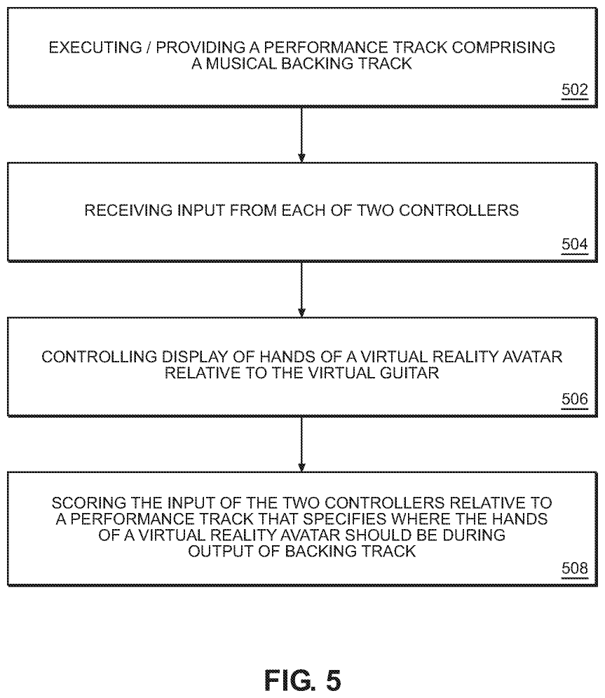

FIG. 5 is a flowchart of an example method of the present disclosure. The method includes a step 502 of executing a performance track comprising a musical backing track. The performance track is separated into a series of sequences that are based on a guitar part of the musical backing track. This could include a rhythm or lead guitar part in the musical backing track.

The series of sequences define how the user should virtually play the guitar during the musical backing track. It will be understood that the user is utilizing two controllers, a neck hand position controller and a strumming hand controller. One controller is used to control the position of the user's hand on the neck of the virtual guitar and other controller is used to control how the user strums the virtual guitar.

Thus, the method comprises a step 504 of receiving input from each of two virtual reality controllers. The method also includes a step 506 of controlling display of hands of a virtual reality avatar relative to the virtual guitar. In some embodiments, the virtual reality avatar and the virtual guitar are displayed within a virtual reality headset. Respective movement of the virtual reality avatar corresponds to how the user moves the two controllers.

This method can also include a step 508 of scoring the input of the two controllers relative to a performance track that specifies where the hands of a virtual reality avatar should be during output of a backing track.

In some embodiments, the process of controlling the display of hands of a virtual reality avatar includes selectively moving a neck hand of the virtual reality avatar based on movement of the neck hand position controller, as well as selectively moving a strumming hand of the virtual reality avatar based on strumming action produced using the strumming hand controller.

According to some embodiments, the virtual reality system is configured to implement a virtualized guitar strap or locked position of the virtual reality guitar. The strap can be display with respect to the virtual reality avatar and/or virtual reality guitar. In other instances, the strap is not displayed but is utilized as a virtual anchor point(s) to maintain a consistent position of the virtual reality guitar with respect to the controllers utilized by the user. The point at which the virtual reality guitar is anchored is referred to as the locking pivot point.

Thus, when the user is not utilizing the controllers to play the virtual reality guitar the virtual reality system will maintain the virtual reality guitar in a consistent position when the user is moving or has their hands away from the virtual reality guitar. This functionality allows the user to be able to quickly and easily move the controllers back into playing positions without having to lose track of a position of the virtual reality guitar.

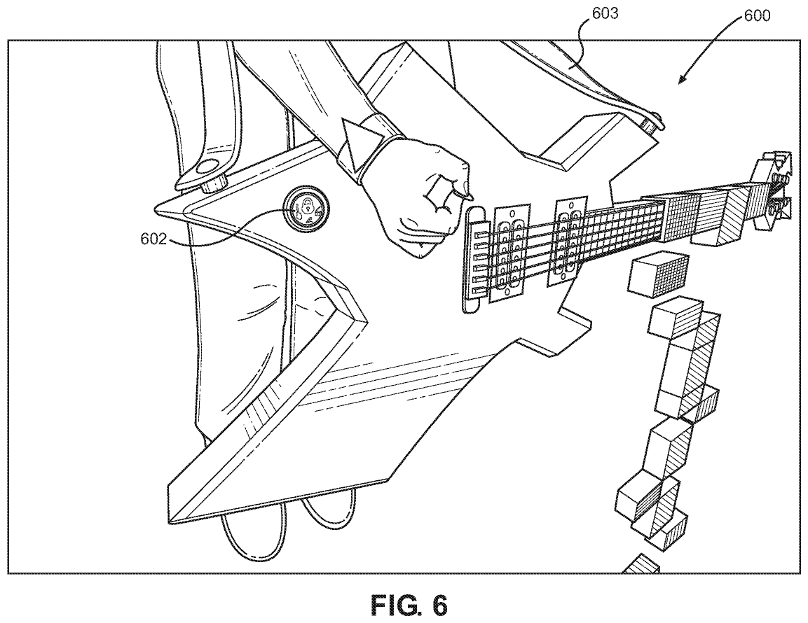

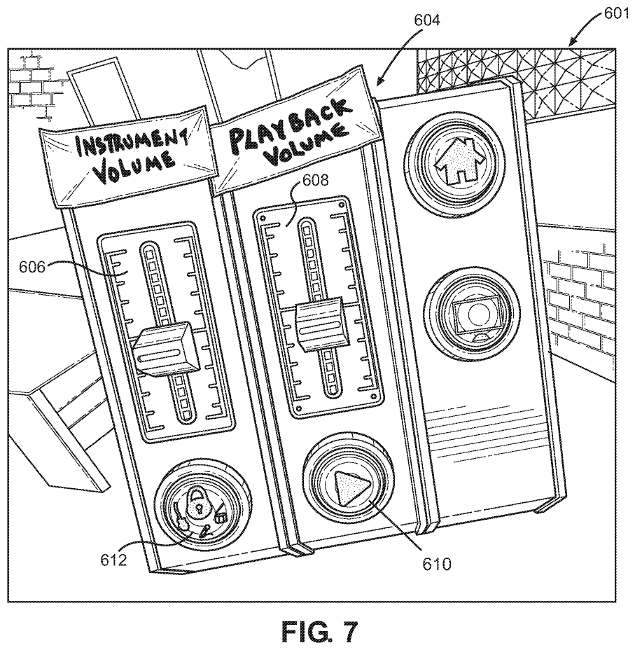

In various embodiments, a placement of the virtual reality guitar and securement using a virtual strap is based on a triangulated playing position determined from the location of the first and second controllers (i.e., how the user “holds” and plays the virtual reality guitar) as well as a location of a headset of the virtual reality gaming system. Turning to FIGS. 6 and 7, the user can lock the virtual reality guitar with the virtual reality strap 603 using a button 602 displayed on an example virtual reality guitar 600. Once the button 602 is activated, the virtual reality gaming system can determine a position of the virtual reality guitar 600 relative to the controllers and headset and determine a virtually strapped position of the virtual reality guitar 600. Once determined, the virtual reality guitar 600 is locked into position such that if the user moves the controllers away from the virtual reality guitar 600 (i.e., moves their hands away from the guitar), the virtual reality guitar 600 remains in position relative to the body of the virtual reality avatar.

In another example embodiment, the button 602 can appear or disappear on the virtual reality guitar 600 according to user movements. For example, once depressed to engage the virtual strap, the button 602 can immediately disappear to prevent unwanted deactivating of the virtual strap. In some embodiments, the button 602 can appear based on a hand gesture such as when the user moves the first or second controller in an arc around their body relative to the headset. This movement mimics the picking up and donning of a guitar strap.

In order to deactivate the virtual reality guitar strap, the user can select a sound mixer interface such as interface 604 as illustrated in FIG. 7. This interface 604 can be positioned somewhere in the virtual reality environment 601, such as just offstage, or can be displayed upon a specific set of gestures or button actuation on the controllers. The interface 604 includes an instrument volume slider 606 that allows the user to select a volume level for the virtual reality guitar, as well as a music (backing track) volume level using a playback volume slider 608. The user can start and stop the backing track using button 610. In some embodiments, the virtual reality strap is deactivated using unlock button 612. In one or more embodiments, the virtual reality strap can be deactivated by the user moving their virtual reality avatar into a specific area of the virtual reality environment 601, rather than using the unlock button 612.

In one or more embodiments, rather than using the unlock button 612, the user can deactivate the virtual reality strap by bending down or over the virtual reality guitar.

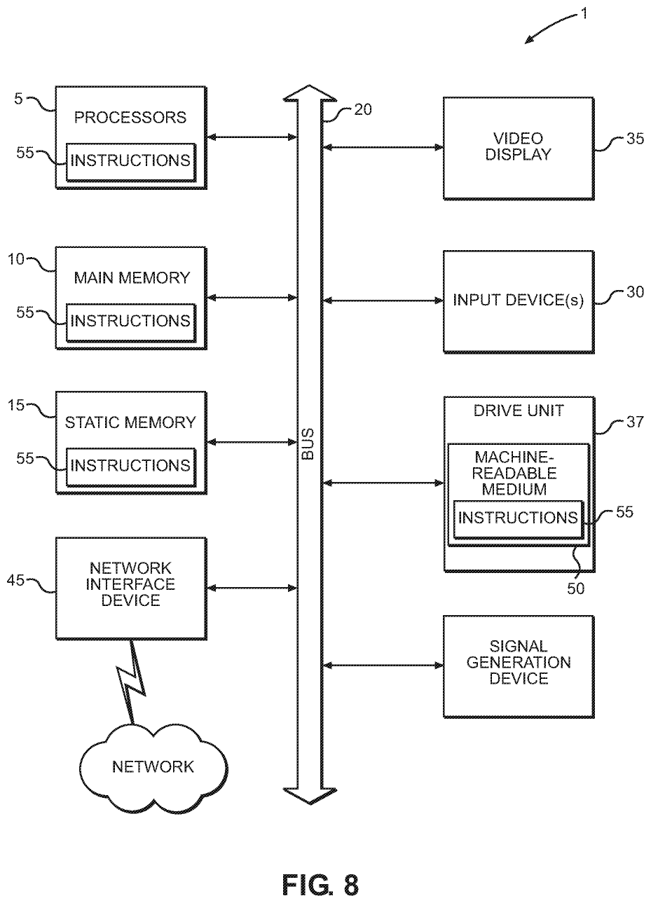

As noted herein, the virtual reality musical experiences disclosed herein can be facilitated through the use of a virtual reality system. In some embodiments, this virtual reality system includes some or all of the components of the computer system disclosed with respect to FIG. 8. The virtual reality system can be embedded into a virtual reality display such as a headset. The virtual reality system is a specifically configured computing device that is configured to provide a portion or all of the virtual reality musical features described herein.

Also, it will be understood that while the disclosure focuses on the specific virtual reality musical experience of playing a guitar, the present disclosure can be readily adapted to other instruments such as a piano, where a virtual reality piano is divided into a plurality of sections. Another example includes any other virtual reality stringed instrument and/or any other musical instrument that requires the use of both hands.

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be, for example, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within static memory 15 and/or within the processors 5 during execution thereof by the computer system 1. The main memory 10, static memory 15, and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure. For example, the technology is not limited to use for stopping email threats, but applies to any messaging threats including email, social media, instant messaging, and chat.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
generating a virtual reality avatar of a musician and a virtual reality guitar;
receiving input from a first controller that is indicative of a neck hand position of the first controller relative to a virtual neck of the virtual reality guitar, as well as input from a second controller that is indicative of a strumming hand movement performed using the second controller;
adjusting:
a neck hand position of the virtual reality avatar, within a virtual reality display, in response to the neck hand position of the first controller in real-time; and
a strumming hand action of the virtual reality avatar, within the virtual reality display, in response to the strumming hand action of the second controller in real-time; and
scoring the neck hand position and the strumming hand action in real-time.

2. The method according to claim 1, wherein the virtual neck of the virtual reality guitar is divided into unique sections.

3. The method according to claim 2, wherein each of the unique sections is associated with a unique hue.

4. The method according to claim 3, further comprising providing a performance track, the performance track comprising sequences, each of the sequences comprising a required neck hand position and a required strumming hand action, wherein each of the sequences has a duration of time during which the required neck hand position and the required strumming hand action are performed.

5. The method according to claim 4, wherein the required neck hand position is indicative of where the neck hand position of the first controller should be during the duration of time and the required strumming hand action comprises parameters of the strumming hand movement of the second controller.

6. The method according to claim 5, wherein the duration of time is indicated by a time bar displayed underneath the virtual reality guitar.

7. The method according to claim 6, wherein the time bar is displayed immediately prior to the duration of time so as to guide a user in positioning the first controller to ensure that the neck hand position is in the required neck hand position associated with the sequence.

8. The method according to claim 7, wherein the time bar comprises a length that corresponds to the duration of time.

9. The method according to claim 1, further comprising playing a backing track during the step of adjusting.

10. A method, comprising:
receiving input from each of two controllers comprising a neck hand position controller and a strumming hand controller;
controlling display of hands of a virtual reality avatar relative to a virtual reality guitar, within a virtual reality headset based on input from the two controllers; and
scoring the input of the two controllers relative to a performance track.

11. The method according to claim 10, wherein controlling display of hands of a virtual reality avatar within a virtual reality headset in real-time based on input from the two controllers further comprises:
selectively moving a neck hand of the hands based on movement of the neck hand position controller; and
selectively moving a strumming hand of the hands based on strumming action produced using the strumming hand controller.

12. The method according to claim 11, wherein scoring the input of the two controllers relative to a performance track further comprises increasing a score as the strumming hand controller is positioned within a strumming area of the virtual reality guitar and performing a strumming action, and also as the neck hand position controller is in a correct position on a neck of the virtual reality guitar.

13. The method according to claim 12, wherein the strumming action is performed within the strumming area and the neck hand position controller is in the correct position on the neck of the virtual reality guitar.

14. A system, comprising:
a processor; and
a memory for storing instructions, the processor executing the instructions to:
generate a virtual reality avatar of a musician and a virtual reality guitar within a virtual reality headset;
receive input from a first controller that is indicative of a neck hand position of the first controller relative to a virtual neck of the virtual reality guitar, as well as input from a second controller that is indicative of a strumming hand movement performed using the second controller; and
adjust:
a neck hand position of the virtual reality avatar in response to the neck hand position of a user in real-time as determined from a position of the first controller; and
a strumming hand action of the virtual reality avatar in response to the strumming hand action in real-time as determined from a position of the second controller.

15. The system according to claim 14, wherein the processor is further configured to score the neck hand position of the user and the strumming hand action in real-time.

16. The system according to claim 15, wherein the virtual neck of the virtual reality guitar is divided into unique sections and each of the unique sections is associated with a unique hue.

17. The system according to claim 16, wherein the processor is further configured to:
provide a performance track, the performance track comprising sequences, each of the sequences comprising a required neck hand position and a required strumming hand action, wherein each of the sequences has a duration of time; and
wherein the required neck hand position is indicative of where the neck hand position of the first controller should be during the duration of time and the required strumming hand action comprises parameters of the strumming hand movement of the second controller.

18. The system according to claim 17, wherein the duration of time is indicated by a time bar displayed underneath the virtual reality guitar, and wherein the time bar is displayed immediately prior to duration of time so as to guide a user in positioning the first controller to ensure that the neck hand position is in the required neck hand position associated with the time bar.

19. The system according to claim 18, wherein the time bar comprises a length that corresponds to the duration of time.

20. The system according to claim 18, further comprising playing a backing track during the step of adjusting.
